(19) United States
(12) Patent Application Publication
(10) Pub. No.: US 2003/0084261 A1
(43) Pub. Date: May 1, 2003

(54) Method for reordering commands to a storage device

(76) Inventors: James M. Byrd, Fremont, CA (US); Ebrahim Hashemi, Los Gatos, CA (US)

Correspondence Address: Robert C. Kowert, Conley, Rose, & Tayon, P.C., P.O. Box 398, Austin, TX, 78767-0398, US

(21) Appl. No.: 10/037,099

(22) Filed: Oct. 29, 2001

(51) Int. Cl. G06F 13/00

(52) U.S. Cl. 711/167

(57) ABSTRACT

Commands requesting access to a storage medium may be reordered by locating an insertion point for a new command in a first list of commands in a command queue and checking at least one of the following conditions: that the end of the command queue is within a first number of queue elements from the first insertion point; and/or that inserting the new command at the insertion point would not cause the first list to exceed a maximum list size. If the condition(s) are met, the new command may be inserted at the insertion point; otherwise, another insertion point may be selected. Thus, insertion points may be restricted to those that occur within a first number of queue elements from the end of the queue and/or to those that do not cause any lists within the command queue to exceed a certain size.

### BACKGROUND OF THE INVENTION 1. Field of the Invention

This invention relates to computer data storage systems, and more particularly, to reordering commands being presented to a storage device such as a hard drive or a CD-ROM drive. 2. Description of the Related Art

Hard drives, CD-ROM (Compact Disk-Read Only Memory) drives, and DVD-ROM (Digital Versatile Disk-Read Only Memory) drives (as well as CD-R, CD-RW, DVD-R, DVD-RW, DVD-RAM, etc.) are popular storage devices in computer systems. These storage devices are similar in that they access a circular storage media (e.g., a hard disk platter, CD, or DVD) by moving a storage media reader to a certain location and spinning the storage media until the desired storage location can be accessed by the storage media reader. For example, in a hard drive, a head assembly may access magnetic data on a disk platter by moving radially across the surface of the disk platter and waiting for the requested storage location to spin under the head assembly. Similarly, in a CD-ROM or DVD-ROM drive, a head assembly containing a mirror and a read lens may move across the surface of the disk as the disk is spinning in order to read data from the disk. CD accesses tend to be slightly more complicated than hard disk accesses. For example, instead of having cylinders or tracks like a hard disk platter, CDs may have a long continuous spiral of bits, which may complicate randomly accesses to specific pieces of data. Also, CLV (Constant Linear Velocity) CD drives may change speed frequently when performing random accesses.

One consequence of using spinning storage media like CDs and hard drives is that access time depends, at least in part, on seek latency, or the time it takes for the head assembly to move from its pre-access position to the position in which the requested storage location can be accessed. Additionally, once the head assembly is positioned, the drive has to wait until the requested storage location is rotated into position to be accessed (i.e., rotational latency). Since moving the head assembly and rotating the storage media involve physical movement, physically accessing the requested storage location may take significantly longer than the time it takes to actually read the data from storage location.

In order to improve access performance, commands to a disk may be queued and reordered before the requested accesses are performed. Commands direct the storage device to access (e.g., in order to perform a read or write) a specified location on the storage medium. The commands in the command queue may be reordered in order to reduce the movement of the head assembly when the drive performs the reordered accesses. Commands are often ordered using an elevator seeking algorithm. A typical elevator seeking algorithm orders commands so that successive accesses are performed with a reduced amount of back and forth movement of a drive's head assembly. For example, one type of elevator seeking algorithm orders commands so that each queued commands can be performed as the head assembly sweeps from the edge of the storage media to the center (or vice versa). This way, the head assembly moves in a single direction from a requested storage location near the outer edge of the storage media to a requested storage location near the center of the storage media. Many variations on elevator seeking algorithms are available. For example, in one variation, commands may be queued in an order that allows slight back and forth movement of the head assembly but reduces the time spent waiting for a requested storage location on the storage media to rotate under the head assembly.

Logical block addressing is often used to identify each storage location of a disk. For example, if a hard disk has 89,355 cylinders, 16 heads, and 63 sectors, that disk may be described as having 90,069,840 data sectors. Each data sector may be identified by a unique logical block address (LBA), and the sectors may be numbered from 0 to 90,069,839. The data sectors may be numbered in a way that corresponds to the movement of the head assembly. For example, a data sector in the outermost cylinder or storage location may be data sector 0 and the sectors may be numbered so that the numbers increase towards the innermost cylinder or storage location. Commands to be sent to the disk drive may specify which data sector to access using an LBA, and an elevator seeking algorithm may order the commands by comparing the LBA of a new command to the LBA's of the commands already in the queue.

One problem with conventional elevator seeking algorithms is that they tend to be optimized for sequential accesses. For example, a first user (e.g., a program in a multitasking environment) may request data at two hundred sequential LBAs (e.g., LBAs 1-200). After the first command in that series is asserted (e.g., specifying LBA 1), a second user may request data at a single LBA that is greater than all of the first user's requested LBAs (e.g., LBA 20,000). If the two users' commands are sorted into a queue using an ascending elevator seeking algorithm, the first user's additional 199 commands (e.g., specifying LBAs 2-200) may be inserted into the queue in front of the second user's command, effectively passing the second user's command in the queue. As a result, the second user's command may not be performed until after all of the sequential commands have been performed. In contrast, if the commands were not reordered, the second user's command would be the second command that was performed. As this example shows, even though an command reordering algorithm may improve performance for sequential accesses, it may provide significantly worse performance for random or non-sequential accesses than if no reordering algorithm is used at all. Accordingly, in a system that has a significant volume of non-sequential accesses, a conventional reordering algorithm may cause many commands to starve in the queue.

### SUMMARY

Various embodiments of methods and systems for reordering commands in a command queue are disclosed. In one embodiment, a method of ordering commands involves receiving a new command and locating a first insertion point for the new command in a first list of commands in a command queue. The first insertion point may be checked to make sure that inserting the new command at the first insertion point would not cause the first list to exceed a maximum list size and/or to make sure that the first insertion point is within a certain number of queue elements from the end of the command queue. If the applicable condition(s) are met, the new command may be inserted at the first insertion point. If the applicable condition(s) are not met, a second insertion point for the new command may be selected. Thus, insertion points may be restricted to those that occur within a first number of queue elements from the end of the queue and/or to those that do not cause any lists within the command queue to exceed a certain size. Restricting insertion points in this way may decrease the likelihood that commands in the command queue will starve.

In one embodiment, another insertion point may be selected in response to determining that the end of the command queue is not within M queue elements from the first insertion point, where M=X−(N MOD X), N is a number of queue elements in the command queue before the first insertion point, and X is a constant.

Locating insertion points may involve using an elevator seeking algorithm or a shortest seek time first algorithm in some embodiments. Some embodiments may also select insertion points that reduce a rotational latency between successive accesses in a list in the queue.

In some embodiments, a computer readable medium includes program instructions computer executable to order commands being presented to a storage medium. The program instructions may be executable to receive a new command, locate a first insertion point for the new command in a first list of commands in a command queue, and check whether an end of the command queue is within a first number of queue elements from the first insertion point and/or that inserting the new command at the first insertion point would not cause the first list to exceed a maximum list size.

In another embodiment, a storage device such as a disk drive or a CD or DVD drive may include a command buffer configured to store a plurality of commands in one or more lists and a controller coupled to the command buffer. In response to a new command being presented to be stored in the command buffer, the controller may be configured to locate a first insertion point for the new command in a first list stored in the command buffer. The controller may be configured to check that inserting the new command at the first insertion point would not cause the first list to exceed a maximum list size and/or that the first insertion point is within a certain number of commands from the final command in the buffer.

In one embodiment, a method of inserting commands into a command queue involves receiving a new command and locating a first insertion point within a range of potential insertion points within the command queue. The range of potential insertion points begins a constant number (greater than one) of elements from the end of the queue. The method may also involve locating a second insertion point in response to determining that inserting the new command at the first insertion point would cause a first list within the queue to exceed a maximum list size.

In some embodiments, a system for ordering commands requesting access to a storage medium includes receiving means configured to receive a new command and selecting means configured to locate a first insertion point for the new command in a first list of commands in a command queue. The selecting means may be configured to check that an end of the command queue is within a first number of commands from the first insertion point and/or that inserting the new command at the first insertion point would not cause the first list to exceed a maximum list size. If the applicable condition(s) are not met, the selecting means may select a second insertion point. The system may also include reordering means configured to insert the new command into the command queue at the first insertion point if the applicable condition(s) are met. In one embodiment, the receiving, selecting and reordering means may be included in device driver software configured to operate as shown in FIGS. 3-5A. In another embodiment, the receiving means may be included in a drive controller of a disk drive and the selecting and reordering means may include a queue controller, as shown in FIGS. 6-7.

### BRIEF DESCRIPTION OF THE DRAWINGS

FIG. 1 shows an example of a command queue implemented as a linked list.

FIG. 2 shows how a new command may be inserted into a command queue in one embodiment.

FIG. 3 illustrates one embodiment of a command queue where insertion points are restricted to those that do not cause any list to exceed a maximum list size.

FIG. 4 shows another embodiment of a command queue where insertion points are restricted to those that are located within a specified number of elements from the end of the queue and to those that do not cause any list within the command queue to exceed a specified list size.

FIG. 5 is a flowchart of one embodiment of a method of inserting an command into a command queue.

FIG. 5A shows another embodiment of a method of inserting a command into a command queue.

FIG. 6 shows one embodiment of a disk drive.

FIG. 7 is a block diagram of one embodiment of a disk drive controller configured to reorder commands in a command buffer.

FIG. 8 shows one embodiment of a data processing system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include” and derivations thereof mean “including, but not limited to.” The term “connected” means “directly or indirectly connected,” and the term “coupled” means “directly or indirectly connected.”

### DETAILED DESCRIPTION OF EMBODIMENTS

Many drives (e.g., various hard drives, CD-ROM drives, etc.) may have an associated command queue to store pending commands. For example, some operating systems and/or device drivers may maintain a queue of commands for a particular drive. Also, a drive may maintain an internal command queue. Commands may be inserted into a command queue at insertion positions that are selected to decrease the back and forth movement of the drive's head assembly or assemblies or otherwise increase the overall performance of the commands. For example, the commands may be inserted into a queue using an elevator seeking algorithm that orders commands into ascending and/or descending lists based on the relative magnitudes of the LBAs specified in the queued commands. The insertion positions into which a new command can be inserted into a particular drive's commands queue or buffer may be restricted to increase the likelihood that the commands that are already in the queue will not be starved. Generally, starving refers to the situation where a command remains in the command queue for longer than a desired amount of time or a certain number of turns (a turn is a time in which a single queued command is performed by the drive controller) or clock cycles.

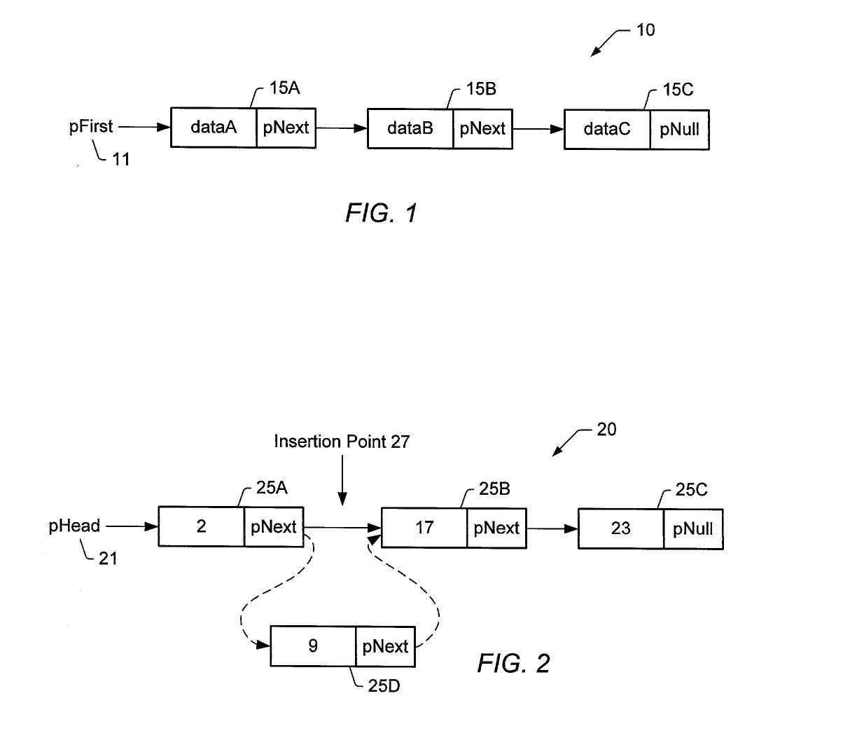

In many embodiments, software (e.g., an operating system or a device driver) may manage a command queue. Commands may be stored in a linked list-type data structure like that shown in FIG. 1. In FIG. 1, a command queue 10 contains several elements 15A-15C (collectively referred to as elements 15). In one embodiment, each time a drive controller finishes performing a command, it may receive the command corresponding to the entry 15A at the head of the command queue 10 as the next command to perform. An entry corresponding to a command may be removed from the head of the queue just before (or just after) that command is performed. As elements 15B-15C age, they may move closer to the head of the queue. As shown, each element 15 in the list may store data and a pointer to the next element, pNext. The data stored in each element may identify the LBA to access and the type (e.g., read or write) of access requested by a corresponding command. The first element 15A in the queue is identified by a pointer 11 to the head of the queue, phead. The last element in the queue may contain a null pointer, pnull, instead of a pointer to the next element. In one embodiment, the last element in the queue may be identified by an end of queue pointer (not shown).

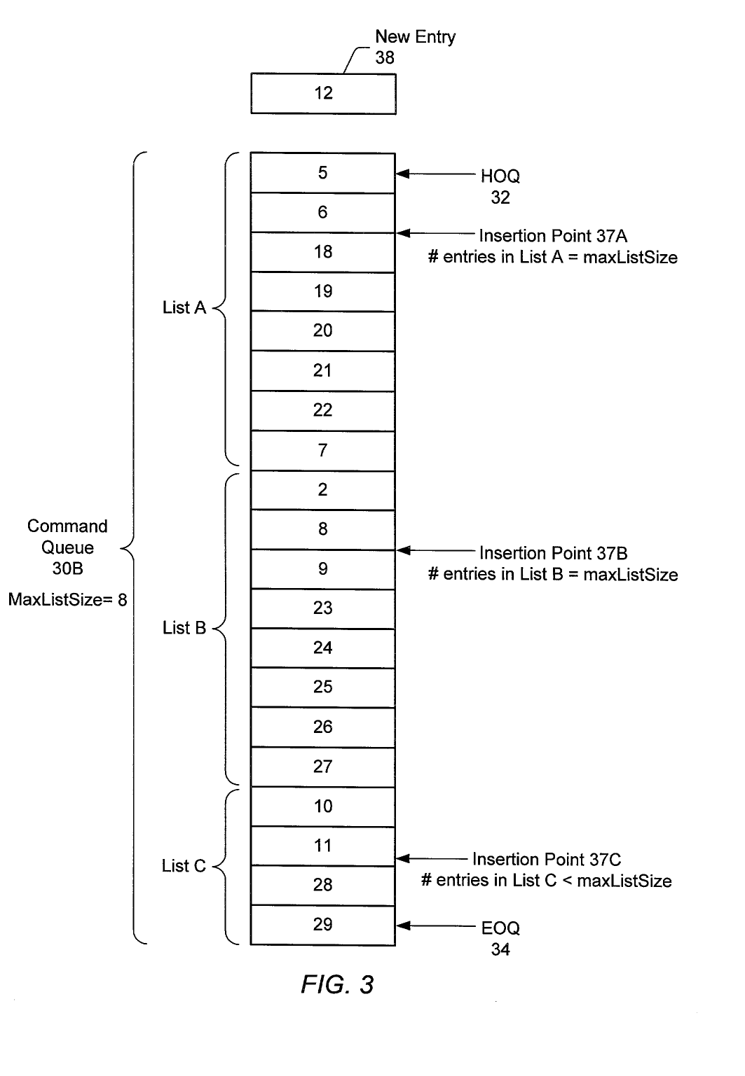

To insert a new command into a list within a queue, an elevator seeking algorithm (or some other command reordering algorithm) may be used to search for an insertion point in the list. As shown in FIG. 2, commands may be ordered according to their LBAs to form an ascending LBA queue 20 that contains elements 25A-25C. If a new command 25D specifies LBA 9, the insertion point 27 for the new command 25D may be between a command 25A that specifies LBA 2 and a command 25B that specifies LBA 17. The new element 25D may be inserted by setting that its pNext to point to element 25B and modifying element 25A's pnext to point to the new element 25D.

In some embodiments (e.g., those where an operating system maintains the command queue), specific information about the particular configuration of the drive being accessed may not be available to the device managing the queue. As a result, commands may be reordered based on the information specified in the commands (e.g., LBAs) as opposed to more specific features of the drive (e.g., seek latency, rotational latency, CHS (Cylinder, Head, Sector) information, etc.). In other embodiments (e.g., those where a drive controller manages the command queue), commands may be reordered based on the specific features of the particular drive being accessed.

In FIG. 2, the illustrated command queue 20 contains a single ascending LBA list of commands. In many embodiments, a command queue may contain several successive ascending or descending LBA lists. In other embodiments, successive lists may alternate between ascending and descending lists. A new list may be created for commands that have already been passed (e.g., because the head assembly has already moved past the requested storage location) in the first list. For example, if an elevator seeking algorithm is being used and a new command specifying LBA 1 is received, that command may not be inserted into the list (whose first element has an LBA of 2) shown in FIG. 2 since the magnitude of the new command's LBA is smaller than any of the other requested LBAs in the list, performing the new command may involve moving the drive's head assembly in the direction opposite to the direction in which it is currently moving. Thus, in order to reduce the back and forth movement of the head assembly, the new command may be inserted at the end of the queue 20 as the first element in a new list.

In some embodiments, the insertion points for new elements may be restricted based on the size of each list in the queue. For example, once a list within the queue grows to a certain size, new elements may not be inserted into that list, even if the end of the list is also the end of the queue. Instead, new elements may be inserted into a new list.

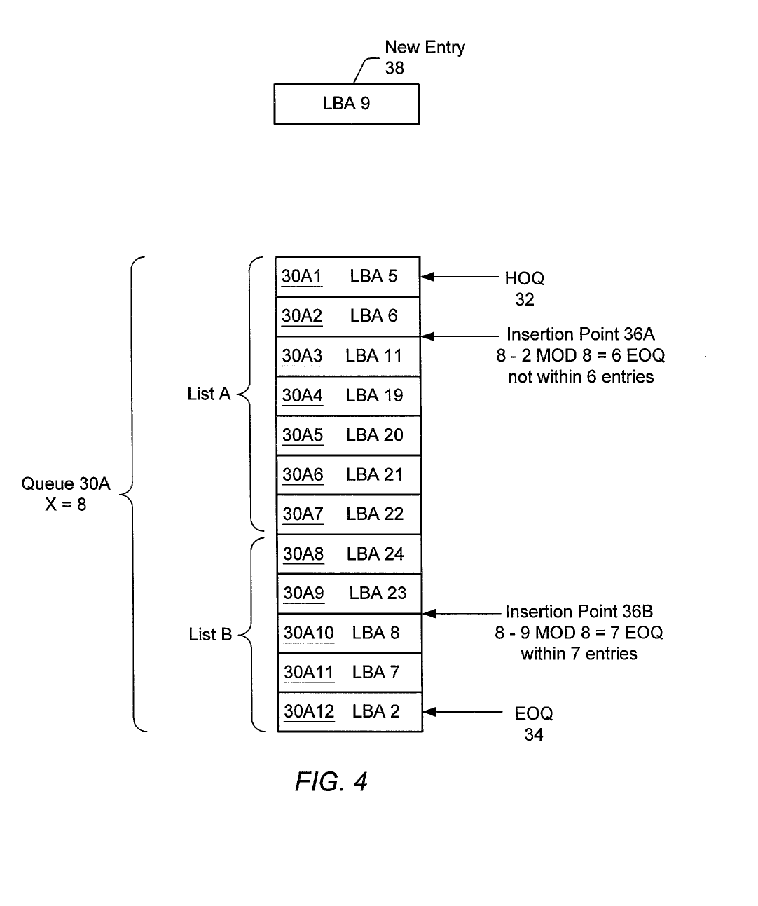

Accordingly, in one embodiment, insertion points may be limited to those that do not cause a list to have more than a maximum number of elements. Looking at FIG. 3, a command queue 30B may contain 20 commands when a new command is received. The commands may be ordered in successive ascending lists, Lists A-C, and each list may have a maximum of eight elements. When a new command 38 is received, List A may have eight elements, List B may also have eight elements, and the final list (List C) may have four elements. A potential insertion point (37A, 37B, and 37C) for new entry 38, which specifies LBA 12, may exist in each of the three lists. However, since Lists A and B already have the maximum number of entries, the insertion point at which the new command may be inserted into the queue may be restricted to insertion point 37C within List C.

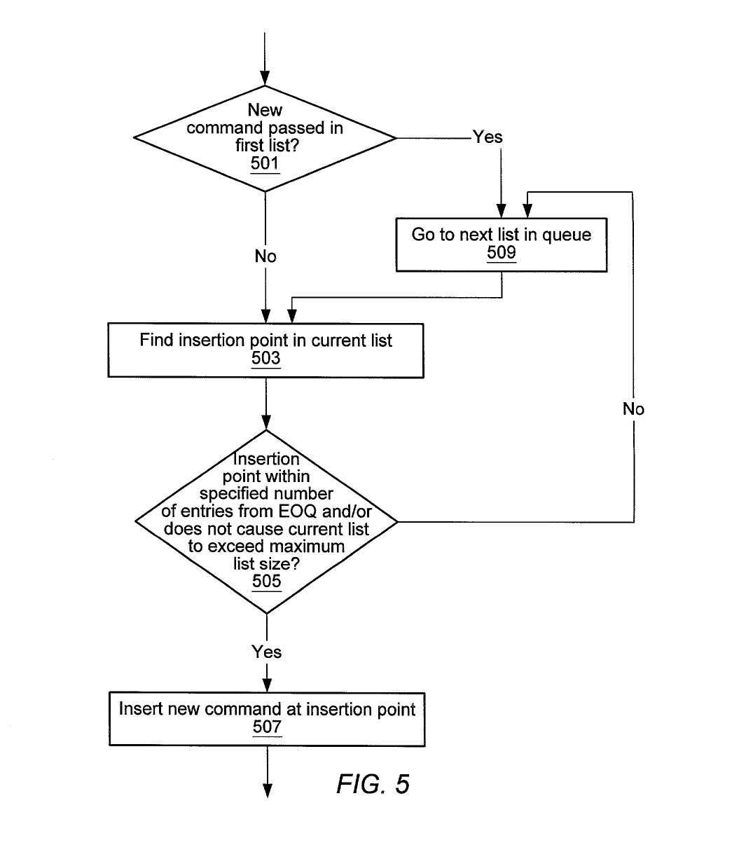

Note that in the embodiment described with respect to FIG. 3, it may be possible for certain commands to starve, depending on the frequencies at which commands are inserted into and removed from the queue and the relative addresses of the commands that are received. For example, if a command is removed from List A just before a new command that can be inserted into List A is received, the new command may be inserted into List A (since List A now has less than the maximum number of elements). If this process continues (e.g., another command is removed from List A before another command, which can also be inserted into List A, is received), commands in Lists B and C (and possibly some of the commands in List A) may starve. In some embodiments, the likelihood of commands starving may be reduced by an additional restriction limiting the insertion points to those that occur within a certain number of elements or lists from the end of the queue. For example, in one embodiment, the insertion points may also be restricted to those that occur in the final two lists in the queue. In another embodiment, the insertion points may be restricted to those that occur within a certain number of elements from the end of the queue. In yet another embodiment, a modulo formula like the one described below with respect to FIG. 4 may be used to restrict insertion points.

In some embodiments that restrict insertion points based on list locations or sizes within a command queue, it may be difficult to determine where a particular list ends and another begins within the queue. For example, if the queue includes multiple ascending lists of commands, it may be difficult to correctly identify where a first list ends if each command in the succeeding list identifies a larger LBA than any commands in the first list. Similarly, if the queue alternates between ascending and descending lists, the first element in a descending list may have a larger LBA than the preceding element, which is the final element in an ascending list. In some embodiments, status flags or bits may identify whether a particular queue element is the beginning and/or ending element in a list.

In some embodiments, insertion points may be limited to those that are within a constant number of commands or lists from the end of the command queue. For example, insertion points for a new command may be restricted to those found within 10 commands from the end of the queue. Thus, if commands in a first list within the queue are all more than 10 commands from the end of the queue, the new command may not be inserted into the first list. In a similar example, insertion points may be limited to those found within the last two lists in the queue. Restrictions such as these may increase the likelihood that commands within the queue do not starve.

If the insertion points for a new element are restricted to insertion points within a constant number of commands or lists from the end of the queue, it may still be possible for situations to arise in which certain commands starve. Accordingly, some embodiments may additionally restrict insertion points to limit the size of each list in the queue, as described above.

In one embodiment, the insertion points may be restricted to those that are within a certain number of elements from the end of the queue and to those that prevent each list within the queue from exceeding a certain size. For example, in some embodiments, insertion points in the various lists may be restricted to those at which the end of queue is found within X−[(number of entries before the insertion point) MOD X] elements from the insertion point. The value of X may correspond to the maximum size of each list within the queue as well as the number of elements from the end of the queue to which insertion points are restricted.

X may be a constant that is selected by balancing the performance of sequential accesses against that of random accesses. X may be selected by running a series of benchmarks or other tests in order to analyze the performance impact of different values of X on both sequential accesses and random accesses. In some embodiments, a value of X may be selected that improves the performance of random access (although not necessarily to the performance level that would be obtained if commands were executed in the order in which they were received) without decreasing the performance of sequential accesses beneath a desired level. Generally, as X increases, sequential access performance may increase, and as X decreases, random access performance may increase. In some embodiments, the specific value of X may also be selected based on how efficiently modulo operations can be performed with that value (e.g., 128 (2⁷) may be used more efficiently instead of 132).

FIG. 4 shows one embodiment of a command queue 30A. For ease of explanation, the command queue 30A contains 12 elements and X equals eight. It is noted that in many embodiments, there may be more (or fewer) elements in command queue 30A at any given time and the value of X may be larger (or smaller) than the one used here.

In FIG. 4, the queue 30A contains an ascending list, List A, followed by a descending list, List B. List A is closest to the head of the queue (HOQ) 32 and list B is closest to the end of the queue (EOQ) 34. Each element 30A1-30A12 in queue 30A may contain a value representing an address to access (e.g., by specifying an LBA, as shown). Each element 30A1-30A12 may also contain an indication of what type of access to perform at that address and a pointer to the next element in the queue.

A new entry 38 identifies LBA 9. In this example, a first insertion point 36A for the new entry 38 in ascending List A occurs where the preceding element 30A2's LBA <9 and the succeeding element 30A3's LBA ≧9. A second insertion point 36B occurs in descending List B where the preceding element 30A9's LBA >9 and the succeeding element 30A10's LBA ≦9. Note that in other embodiments, insertion points may be defined differently (e.g., insertion points may occur after elements that specify the same LBA as the new command).

Based on the value of X, insertion points at which new commands may be inserted are restricted to those at which the EOQ 34 is found within 8 −[(number of entries before the insertion point) MOD 8] elements. Searching from the HOQ 32, the first possible insertion point 36A occurs between the entries 30A2 and 30A3 in List A. Thus, the number of entries in the queue before insertion point 36A is two, and 8−(2 MOD 8)=6. Since EOQ 34 is not found in the six entries after insertion point 36A (the EOQ is actually 10 entries away from insertion point 36A), new command 38 cannot be inserted at insertion point 36A.

The next insertion point 36B is found in List B between the entries 30A9 and 30A10 in queue 30A. Accordingly, there are nine entries before the insertion point and 8−(9 MOD 8)=7. Since EOQ 34 is found within seven entries from insertion point 36B, the new command may be inserted at insertion point 36B.

In some embodiments, potential insertion points may be saved as they are encountered. For example, in many embodiments, command queue 30A may be structured so that each element contains a pointer to the following element. Thus, the queue may be searched from the head of the queue to the end of the queue. However, in some embodiments, each element may not include a pointer to a preceding element. As a result, it may not be possible to search backwards (e.g., toward the head of the queue) in such an embodiment. If potential insertion points are temporarily saved as they are encountered and the EOQ is not found within the number of entries defined by the restriction, the saved insertion point may be discarded and the queue may be searched for the next insertion point. Thus, looking back at FIG. 4, after insertion point 36A is identified, a temporary pointer to entry 30A2 may be saved to identify that insertion point. The next six entries (entries 30A3-30A8) may be searched for the end of the queue. When entry 30A8 is reached without finding EOQ 34, a new insertion point may be searched for, beginning with entry 30A8. When insertion point 36B is encountered, a temporary pointer to entry 30A9 may be saved. When EOQ 34 is found within seven entries, the temporary pointer may be used to locate insertion point 36B in order to insert the new command 38 into the queue 30A at that point.

When a queue contains both ascending and descending lists, as shown in the embodiment of FIG. 4, locating an insertion point within a list may involve determining whether the list currently being searched is an ascending or descending list. In one embodiment, the direction of the first list may be determined by comparing the relative addresses identified by the first two entries in the queue (e.g., entries 30A1 and 30A2). In FIG. 4, the LBA identified in 30A2 is greater than that identified in entry 30A1, so the first list may be determined to be an ascending list. In some embodiments, direction changes (i.e., places in the queue where successive elements switch from being arranged in descending order to ascending order or vice versa) may be detected, if needed, by comparing the address specified by each element to the address specified in the preceding element. In other embodiments, a direction change may be assumed to have occurred each time the EOQ 34 is not found within the specified number of entries from a particular insertion point. Note that in some embodiments, each entry may be tagged or otherwise identified as being part of an ascending or descending list.

In many embodiments, insertion points may also be restricted so that new commands cannot be inserted as the head of the command queue (unless there are no other commands in the queue). For example, the command stored in the element at the head of the queue may be the command that is currently being processed. Accordingly, inserting a new command as the head of the queue may potentially interrupt execution of another command or otherwise slow down performance.

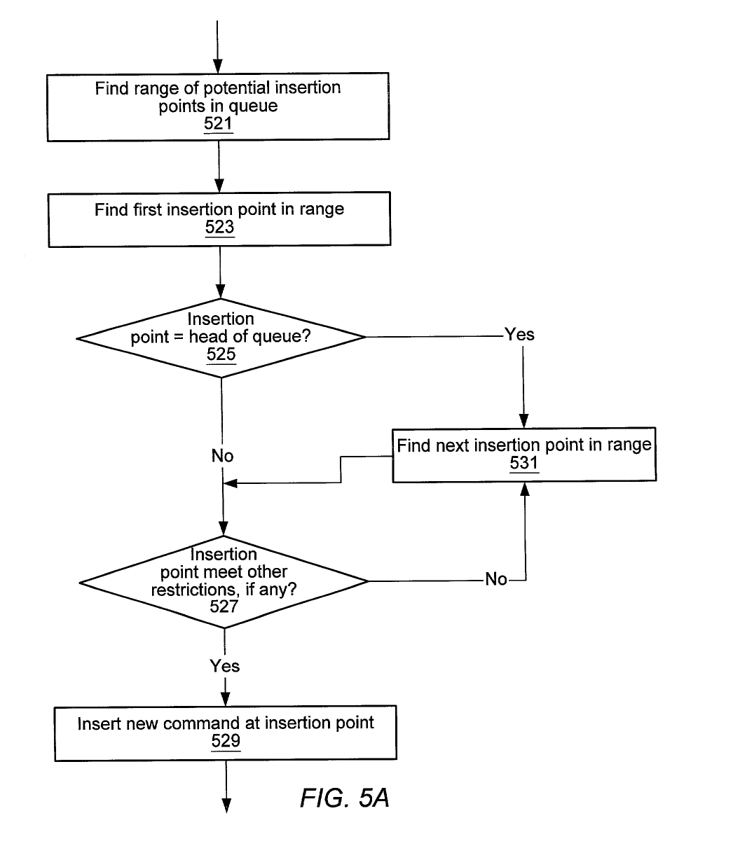

FIG. 5 shows one embodiment of a method of inserting a new command into a command queue. The command queue may include one or more successive lists. Each list may order commands in ascending or descending order. Ascending order may order commands so that they can be sequentially performed as a head assembly moves in one direction across the storage media (e.g., from the outside to the center) and descending order may order commands in the reverse order. In one embodiment, successive lists may alternate between ascending and descending order. Alternatively, each list may be arranged in the same order (e.g., all ascending or all descending). Each element in the command queue may specify a storage location to access (e.g., using an LBA, as shown in FIG. 3) and an operation to perform (e.g., read or write) at that storage location. Additionally, each element may include a pointer to the next element in the command queue.

If the new command has already been passed in the first list in the queue (the first list may be the list containing the element that is currently at the head of the queue), an insertion point may be located in the next list in the queue, as shown at 501 and 509. For example, the new command may be passed in an ascending list if the first element in the list specifies a larger LBA than the new command does. Similarly, in a descending list, the new command may be passed if the first element in the list specifies an LBA that is smaller than the one specified by the new command. In embodiments where lists alternate between ascending and descending lists, determining whether the new command is passed may involve determining whether the first list is an ascending or descending list. For example, the LBAs of the first (e.g., the element at the head of the queue) and second elements in the first list may be compared. Assuming the first element is not the only element in a list, the first list may be a descending list if the first element's LBA is larger than the second element's LBA and an ascending list otherwise.

At 503, an insertion point may be located within the list that is currently being searched (e.g., the first list if the new command was not passed, the second list if the new command was passed). For example, in an ascending list, an insertion point may be a point between an element specifying a LBA that is less than (and/or equal to) the LBA of the new command and an element whose LBA is larger than that of the new command. Accordingly, searching for an insertion point in an ascending list may involve looking for a point at which the next element's LBA is larger than the new element's LBA. In a descending list, finding an insertion point may involve looking for a point where the next element's LBA is smaller than (and/or equal to) the new element's LBA.

In embodiments where successive lists alternate between ascending and descending LBA lists, an insertion point may also occur at the beginning (and/or end) of a list. For example, when the current list being searched is an ascending LBA list, an insertion point may occur between an element whose LBA is smaller than the new command's LBA and an element whose LBA is less than the previous element's LBA (e.g., the insertion point occurs at the end of the ascending list or the beginning of the descending list). Similarly, if a descending list is currently being searched, an insertion point may be found between an element whose LBA is greater than the new command's LBA and an element whose LBA is greater than the previous element's (e.g., the insertion point occurs between the last element in the descending list and the first element of an ascending list).

Once an insertion point is located, it is checked to determine whether it meets the restriction requirement(s), as shown at 505. Thus, may be determined whether the insertion point is within the specified number of elements from the end of the queue and/or whether inserting the new command at the insertion point would cause the current list to exceed the specified maximum list size. For example, checking may involve using the modulo formula described above to determine whether the insertion point meets the restriction requirement(s). If the restriction requirement(s) are satisfied, the new command is inserted at the insertion point, as shown at 507. If the restriction requirement(s) are not met, a new insertion point is located, at 509. This process may repeat until an insertion point that meets the restriction requirement(s) is located.

In some embodiments, searching for an insertion point may also involve tracking the number N of elements between the head of the queue and the insertion point. N may be used to determine whether a new command can be inserted at a particular insertion point. For example, the modulo formula described above may be used to restrict insertion points to those at which the end of the queue is found within M entries, where M=X−[N MOD X].

In some embodiments, it may be desirable to reduce the number of times the operations (e.g., comparisons of the address specified in a new command with the addresses specified in each of the queue elements) used to locate insertion points are performed. Thus, instead of locating insertion points starting at the head of the queue, it may be desirable to start locating insertion points further down in the queue. FIG. 5A illustrates such an embodiment of a method of inserting commands into a command queue. At 521, a range of potential insertion points within the queue is identified. For example, in a queue where each element has a pointer to a preceding element and the possible insertion points are restricted to those that occur within a certain number of elements from the end of the queue, finding the range of potential insertion points may involve moving backwards through the queue from the last element in the queue until the first potential insertion point is reached. Alternatively, if the number of elements in the queue is tracked, the maximum number of elements between the first potential insertion point and the end of the queue may be subtracted from the number of elements currently in the queue to get the number of elements before the first potential insertion point. If each queue element has a pointer to the next element, the range of potential insertion points may be found by moving forward through the queue the calculated number of elements. Thus, if a queue currently contains 135 elements and a modulo formula like the one described above is used to restrict insertion points, the first potential insertion point may occur 64 elements from the end of the queue if X=64. If the queue elements do not have back pointers, the first potential insertion point may be reached by moving from the head of the queue to the 71^{st} element (since 135−64=71=number of elements before the first potential insertion point) in the queue. Operations used to locate insertion points may not be performed on the queue elements traversed in order to reach the first potential insertion.

Once the first potential insertion point is reached, operations used to locate insertion points may be performed (e.g., by moving forward in the queue and examining the relative LBAs identified in each element until an insertion point for the new element is found). Thus, at 523, the first insertion point is located within the range identified at 521.

In some embodiments, new elements may not be inserted at the head of the queue, so if the first insertion point found within the range is at the head of the queue, a new insertion point may be located, as shown at 525 and 531.

In some embodiments, there may be other restrictions on insertion points in addition to being within the range located at 521. For example, in one embodiment insertion points may additionally be restricted to those that do not cause the size of any list within the queue to exceed a maximum list size. If any additional restrictions are being used and the insertion point located at 523 does not meet these restrictions, a new insertion point may be located, as shown at 527 and 531.

Once a suitable insertion point is located, the new command may be inserted into the queue, as shown at 529.

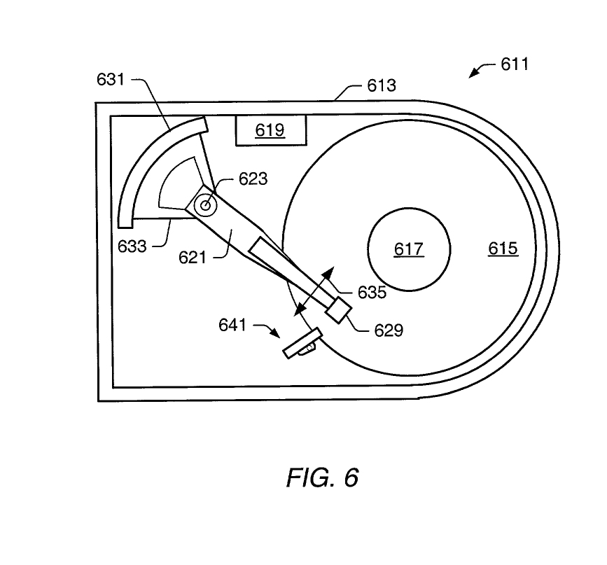

FIG. 6 shows one example of a typical hard drive 600. The hard drive 600 is enclosed in an outer housing 613. The hard drive contains a plurality of stacked, parallel magnetic disks 615 (of which only the top disk is shown). Each magnetic disk 615 has two surfaces, and in some embodiments, each surface may be used to store data. A motor (not shown) may rotate disks 615 around a central drive hub 617. A plurality of stacked, parallel actuator arms 621 may be pivotally mounted to base 613 by a pivot assembly 623. In some embodiments, actuator arms 621 may be curved. A controller 619 may be mounted to the base and configured to selectively move arms 621 so that magnetic disks 615 can be accessed for read and write operations. The controller may also control the motor and make sure the runs at the correct speed, manage read/write operations, implement power management features, handle geometry translation, manage an internal cache and prefetch data into the cache, reorder multiple commands, convert data into different forms, etc.

In the embodiment shown, each arm 621 includes a head assembly 629 that has at least one magnetic read/write head for magnetically reading data from or magnetically writing data to disks 615. In some embodiments, the magnetic read/write heads may be ferrite, metal-in-gap, thin film, MR (Magnetoresistive), or GMR (Giant Magnetoresistive) heads (if MR or GMR heads are used, the read/write head may actually include different elements for reading and writing). A motor assembly 631, which may include a conventional voice coil motor, may be coupled to pivot assembly 623 opposite head assemblies 629. Movement of an actuator drive arm 633 moves head assemblies 629 radially across tracks on the disks 615 until the heads on assemblies 629 settle on the target tracks, as indicated by movement arrow 635. Typically, all of the head assemblies 629 are moved as a single unit.

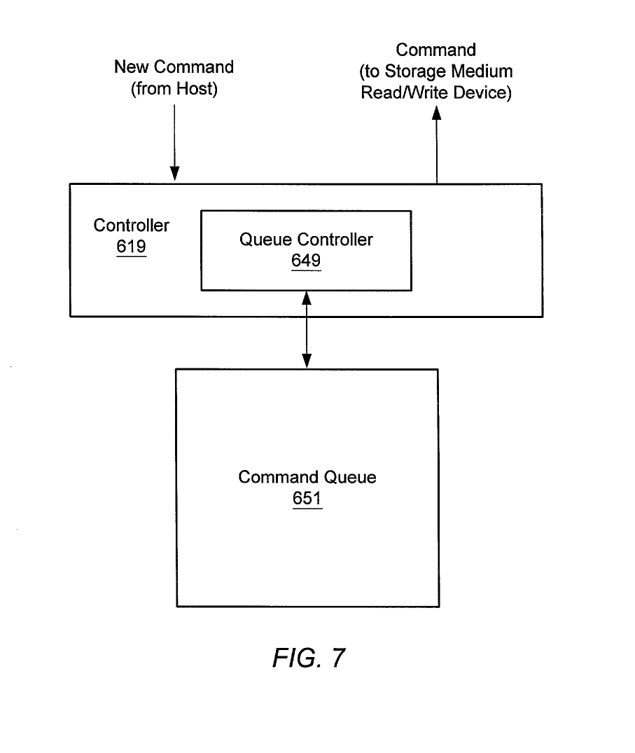

In some embodiments, the commands presented to a drive (e.g., to a hard drive as shown in FIG. 6 or to a CD or DVD drive) may be stored in a command queue or buffer 651 managed by a queue controller 649 in drive controller 619, as shown in FIG. 7. The command queue 651 may employ multiple registers as its storage locations, or the storage locations may be rows of a storage array in one or more memory devices (e.g., RAM, DRAM, etc.). The queue controller 649 may be configured to reorder the commands in the command queue 651. In some embodiments, the queue controller 649 may manage the command queue 651 based on firmware instructions (e.g., stored in a ROM). Alternatively, the queue controller 649 may contain hardware configured to maintain the command queue 651. Commands may be ordered into one or more lists in the command queue 651, and the queue controller 649 may be configured to restrict new commands' insertion points to those that limit the size of each list in the queue and/or to those that occur within a certain number of elements or lists from the end of the queue, as described with respect to FIGS. 2-5A. For example, in one embodiment, the queue controller 649 may limit insertion points to those that occur within X−[(number of elements preceding the insertion point in the queue) MOD X] of the end of the queue.

In some embodiments, the queue controller 649 may select an insertion point for a new command in order to reduce the back and forth movement of the drive's head assembly and/or the total or rotational latency incurred between successive accesses. In addition to selecting one or more insertion points, the queue controller 649 may determine whether any of those insertion points meet the insertion point restriction(s). Alternatively, the queue controller 649 may determine which potential insertion points meet the restrictions and then determine which of those may be used as an actual insertion point for a particular new command.

In some embodiments, the queue controller 649 may insert commands into the queue 651 once a suitable insertion point has been selected. For example, a command may be inserted at an insertion point by shifting commands already in the queue to make room for the new command at the insertion point or by modifying tags contained in each queue entry that identify the storage location of the next command in the queue. In other embodiments, commands may be stored in the order in which they are received into a memory device (e.g., a portion of the command queue 651 or a separate queue or buffer). The queue controller 649 may select insertion points in order to reorder the commands and then store the commands in the new order into the command queue 651.

As commands are executed, they may be removed from the command queue 651. A command may be removed by modifying a register value that stores a pointer to the first element in the queue 651 so that the pointer now identifies the next element in the queue 651. Alternatively, an executed command may be removed by shifting other commands in the command queue up, overwriting the location allocated to that command.

While the above description refers to commands that specify storage locations using LBAs, other embodiments may specify storage locations using different systems. For example, commands to hard drives may be specified using CHS (Cylinder, Head, Sector) or ECHS (Extended CHS, also referred to as “Large Mode”) addressing. In such embodiments, finding a potential insertion point may involve comparing the cylinder and/or sector specified by a new command to the cylinders and sectors specified by the commands that are already in the queue.

Additionally, the restrictions limiting the size of each list in the queue and/or the distance between an insertion point and the end of the queue may apply to embodiments where the commands are ordered using an algorithm other than an elevator seeking algorithm. For example, in some embodiments, commands may be ordered using an SSTF (Shortest Seek Time First) algorithm that arranges commands so that the command that has the shortest seek time (of the commands in a list) after a first command is inserted into the list just after that command (assuming the other insertion point criteria of the particular embodiment are met). Thus, in some embodiments, each list may be organized based on the relative seek time between successive elements. Potential insertion points for a new element may occur at each place within a list at which the seek time to access the address identified in the new command after accessing the address specified in the preceding element is less than the seek time to the address identified in the succeeding element after accessing the address specified in the preceding element. In other embodiments, commands may be ordered in a way that allows some back and forth movement of the head assembly but reduces the time spent waiting for a particular storage location to rotate into a position at which it can be accessed. In these embodiments, insertion points may be located based on both the amount of back and forth movement of the head assembly and the amount of rotational latency to be incurred between performing commands in successive elements in the queue. Some embodiments may also consider the cylinder and/or head skewing used (if used at all) by the particular drive being accessed when selecting insertion points.

For simplicity, the above discussion has avoided discussing read/write collisions (e.g., situations where one user is trying to read data that another user is trying to write to). In some embodiments, finding an insertion point may also involve finding an insertion point that will not cause a read/write collision. However, in other embodiments, the file system and/or the application program requesting the data may be configured to provide commands to the command queue in a way that avoids or recovers from read/write collisions.

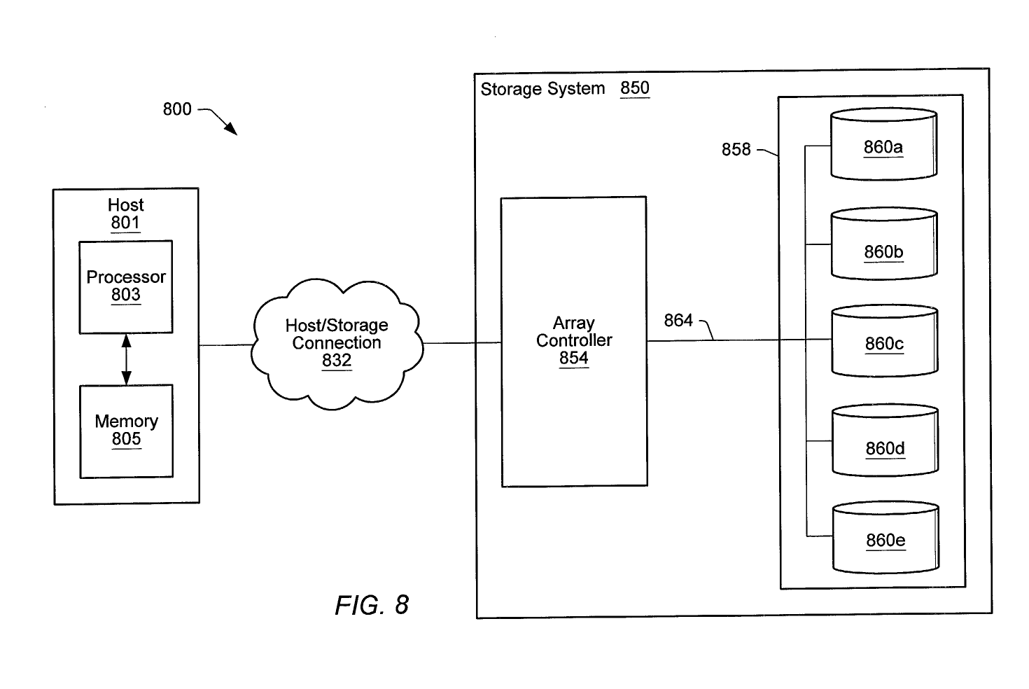

FIG. 8 shows a functional block diagram of one embodiment of a data processing system 800, which includes a host 801 connected to a storage system 850 via host/storage connection 832. Host/storage connection 832 may be, for example, a local bus, a network connection, an interconnect fabric, or a communication channel. Storage system 850 may be a RAID storage subsystem or other type of storage array. In various embodiments, a plurality of hosts 801 may be in communication with storage system 850 via host/storage connection 832.

Contained within storage system 850 is a storage device array 858 that includes a plurality of storage devices 860a-860e (collectively referred to as storage devices 860). Storage devices 860a-860e may be, for example, magnetic hard disk drives, optical drives, magneto-optical drives, tape drives, solid state storage, or other non-volatile memory. As shown in FIG. 8, storage devices 860 are disk drives and storage device array 858 is a disk drive array. Although FIG. 8 shows a storage device array 858 having five storage devices 860a-860e, it is understood that the number of storage devices 860 in storage device array 858 may vary and is not limiting.

Storage system 850 also includes an array controller 854 connected to each storage device 860 in storage array 858 via one or more data paths 864. Data path 864 may provide communication between array controller 854 and storage devices 860 using various communication protocols, such as, for example, SCSI (Small Computer System Interface), FC (Fibre Channel), FC-AL (Fibre Channel Arbitrated Loop), or IDE/ATA (Integrated Drive Electronics/Advanced Technology Attachment), etc.

Array controller 854 may take many forms, depending on the design of storage system 850. In some systems, array controller 854 may only provide simple I/O connectivity between host 801 and storage devices 860 and the array management may be performed by host 801. In other embodiments of storage system 850, such as controller-based RAID systems, array controller 854 may also include a volume manger to provide volume management, data redundancy, and file management services. In other embodiments of the present invention, the volume manager may reside elsewhere in data processing system 800. For example, in software RAID systems, the volume manager may reside on host 801 and be implemented in software. In other embodiments, the volume manager may be implemented in firmware that resides in a dedicated controller card on host 801. In some embodiments, array controller 854 may be connected to one or more of the storage devices 860. In yet other embodiments, a plurality of array controllers 854 may be provided in storage system 850 to provide for redundancy and/or performance improvements.

In one embodiment, host 801 may manage storage system 850. A device driver running on host 801 may be configured to maintain a command queue for commands accessing data on one or more drives 860. The device driver may reorder commands to each drive 860 in order to improve the average access latency. Additionally, the device driver may be configured to reorder the commands in such a way that new commands can be inserted into the command queue at insertion points that occur within a specified number of queue elements from the end of the queue and/or that do not cause any particular list within the queue to exceed a maximum list size, as described with respect to FIGS. 3-5A. The instructions that manage the command queue(s) may be stored in memory 805 and executed by processor 803. Memory 805 may include random access memory (RAM) such as DRAM, SDRAM, DDR DRAM, RDRAM, etc.

In some embodiments, the software for managing the command queue(s) may be stored on another computer readable medium (e.g., a CD, DVD, hard disk, optical disk, tape device, floppy disk, etc.). In order to execute the instructions, the instructions may be loaded into system memory 805. In addition, the computer readable medium may be located in either a first computer, in which the software program is stored or executed, or in a second different computer, which connects to the first computer over a network such as the Internet. In the latter instance, the second computer may provide the program instructions to the first computer for execution. The instructions and/or data used to manage the command queue(s) may also be transferred upon a carrier medium. In some embodiments, a computer readable medium may be a carrier medium such as networks and/or a wireless link upon which signals such as electrical, electromagnetic, or digital signals may be conveyed.

Numerous variations and modifications will become apparent to those skilled in the art once the above disclosure is fully appreciated. It is intended that the following claims be interpreted to embrace all such variations and modifications.

What is claimed is:

1. A method of ordering commands requesting access to a storage medium, the method comprising:
receiving a new command;
locating a first insertion point for the new command in a first list of commands in a command queue;
checking at least one of these conditions:
that an end of the command queue is within a first number of queue elements from the first insertion point; and
that inserting the new command at the first insertion point would not cause the first list to exceed a maximum list size;
if said checking reveals that the at least one of the conditions is not met, selecting a second insertion point for the new command.

2. The method of claim 1, further comprising inserting the new command at the first insertion point if said checking reveals that the at least one of the conditions is met.

3. The method of claim 1, further comprising repeating said checking and said selecting until a final insertion point that meets the at least one of the conditions is selected.

4. The method of claim 1, wherein said selecting a second insertion point occurs in response to determining that the end of the command queue is not found within M queue elements from the first insertion point, wherein M=X−(N MOD X), wherein N is a number of queue elements in the command queue before the first insertion point, wherein X is a constant.

5. The method of claim 1, further comprising saving a first pointer to a first queue element preceding the first insertion point in response to said locating.

6. The method of claim 5, further comprising saving a second pointer to a second queue element preceding the second insertion point in response to said selecting.

7. The method of claim 6, further comprising using the second pointer to locate the second insertion point in order to insert the new command at the second insertion point.

8. The method of claim 1, wherein each queue element in the command queue comprises an address identifier specifying a storage location to access.

9. The method of claim 8, wherein the address identifier comprises a Logical Block Address (LBA).

10. The method of claim 8, wherein the address identifier comprises a Cylinder, Head, Sector (CHS) address.

11. The method of claim 1, wherein said locating a first insertion point comprises using an elevator seeking algorithm to locate the first insertion point within the first list.

12. The method of claim 1, wherein said locating a first insertion point comprises using a shortest seek time first algorithm to locate the first insertion point within the first list.

13. The method of claim 1, wherein said locating a first insertion point comprises locating the first insertion point in order to reduce a rotational latency between successive accesses in the first list.

14. The method of claim 1, wherein said locating a first insertion point comprises locating the first insertion point in response to the new command not being passed in the first list.

15. The method of claim 1, wherein said locating a first insertion point comprises locating the first insertion point in response to the first insertion point not occurring at a head of the command queue.

16. The method of claim 1, wherein each queue element in the command queue comprises a pointer to a next queue element in the command queue.

17. The method of claim 1, wherein successive lists in the command queue alternate between being organized in ascending and descending order.

18. The method of claim 1, wherein successive lists in the command queue are organized in ascending order.

19. The method of claim 1, wherein said checking comprises checking both of the following conditions:
that the end of the command queue is within the first number of queue elements from the first insertion point; and
that inserting the new command at the first insertion point would not cause the first list to exceed the maximum list size;
wherein said selecting occurs in response to either of the above conditions not being met.

20. The method of claim 1, wherein said checking comprises checking both of the following conditions:
that inserting the new command at the first insertion point would not cause the first list to exceed the maximum list size; and
that the end of the command queue is within a first number of lists from the first insertion point;
wherein said selecting occurs in response to either of the above conditions not being met.

21. The method of claim 1, wherein said locating a first insertion point comprises determining whether the first list is an ascending list or a descending list.

22. The method of claim 21, wherein said determining whether the first list is an ascending list or a descending list comprises comparing a relative magnitude of addresses specified in a first and a second queue element in the first list.

23. A computer readable medium comprising program instructions computer executable to order commands being presented to a storage medium, wherein the program instructions are configured to:
receive a new command;
locate a first insertion point for the new command in a first list of commands in a command queue;
check at least one of these conditions:
that an end of the command queue is within a first number of queue elements from the first insertion point; and
that inserting the new command at the first insertion point would not cause the first list to exceed a maximum list size;
if said checking reveals that the at least one of the conditions is not met, select a second insertion point for the new command.

24. The computer readable medium of claim 23, wherein the program instructions are computer executable to insert the new command at the first insertion point if said checking reveals that the at least one of the conditions is met.

25. The computer readable medium of claim 23, wherein the program instructions are computer executable to select the second insertion point in response to determining that the end of the command queue is not found within M queue elements from the first insertion point, wherein M=X−(N MOD X), wherein N is a number of queue elements in the command queue before the first insertion point, wherein X is a constant.

26. The computer readable medium of claim 23, wherein the program instructions are computer executable to save a first pointer to a first queue element preceding the first insertion point in response to locating the first insertion point.

27. The computer readable medium of claim 23, wherein each queue element in the command queue comprises an address identifier specifying a storage location to access.

28. The computer readable medium of claim 27, wherein the address identifier comprises a Logical Block Address (LBA).

29. The computer readable medium of claim 23, wherein the program instructions are computer executable to locate the first insertion point by using an elevator seeking algorithm to locate the first insertion point within the first list.

30. The computer readable medium of claim 23, wherein the program instructions are computer executable to locate the first insertion point in response to the new command not being passed in the first list.

31. The computer readable medium of claim 23, wherein the program instructions are computer executable to locate the first insertion point in response to the first insertion point not identifying a head of the command queue.

32. The computer readable medium of claim 23, wherein each queue element in the command queue comprises a pointer to a next queue element in the command queue.

33. The computer readable medium of claim 23, wherein successive lists in the command queue alternate between being organized in ascending and descending order.

34. The method of claim 23, wherein successive lists in the command queue are organized in ascending order.

35. The computer readable medium of claim 23, wherein the program instructions are computer executable to check both of the following conditions:
that an end of the command queue is within a first number of queue elements from the first insertion point; and
that inserting the new command at the first insertion point would not cause the first list to exceed a maximum list size;
wherein the program instructions are computer executable to select the second insertion point in response to either of the above conditions not being met.

36. The computer readable medium of claim 23, wherein the program instructions are computer executable to check both of the following conditions:
that inserting the new command at the first insertion point would not cause the first list to exceed a maximum list size; and
that an end of the command queue is within a first number of lists from the first insertion point;
wherein the program instructions are computer executable to select the second insertion point in response to either of the above conditions not being met.

37. The computer readable medium of claim 23, wherein the program instructions are computer executable to determine whether the first list is an ascending list or a descending list.

38. The computer readable medium of claim 37, wherein the program instructions are computer executable to compare a relative magnitude of addresses specified in a first and a second queue element in the first list in order to determine whether the first list is an ascending list or a descending list.

39. A storage device comprising:
a command buffer configured to store a plurality of commands in one or more lists; and
a controller coupled to the command buffer;
wherein in response to a new command being presented to be stored in the command buffer, the controller is configured to locate a first insertion point for the new command in a first list stored in the command buffer;
wherein the controller is configured to check at least one of these conditions:
that a final command in a final list stored in the command buffer is within a specified number of commands from the first insertion point; and
that inserting the new command at the first insertion point would not cause a number of commands in the first list to exceed a maximum number;
wherein if the at least one of the conditions is not met, the controller is configured to select a second insertion point for the new command in a second list in the command buffer.

40. The storage device of claim 39, wherein the controller is further configured to reorder the commands in the command buffer so that the new command is stored at the first insertion point in the first list in the command buffer in response to the at least one of the conditions being met.

41. The storage device of claim 39, wherein each queue element comprises a Logical Block Address (LBA).

42. The storage device of claim 39, wherein each queue element comprises a Cylinder, Head, Sector (CHS) address.

43. The storage device of claim 39, wherein the controller is configured to locate the first insertion point for the new command in a first list stored in the command buffer using an elevator seeking algorithm.

44. The storage device of claim 39, wherein the controller is configured to locate the first insertion point for the new command in a first list stored in the command buffer using a shortest seek time first algorithm.

45. The storage device of claim 39, wherein the controller is configured to locate the first insertion point for the new command in a first list stored in the command buffer so that inserting the new command at the first insertion point reduces a rotational latency between successive accesses in the first list.

46. A method of inserting commands into a command queue, the method comprising:
receiving a new command;
locating a first insertion point within a range of potential insertion points within the command queue, wherein the range of potential insertion points begins a constant number of queue elements from an end of the queue, wherein the constant number is greater than one.

47. The method of claim 46, further comprising:
locating a second insertion point in response to determining that inserting the new command at the first insertion point would cause a first list within the queue to exceed a maximum list size;
inserting the new command at the second insertion point.

48. A system for ordering commands requesting access to a storage medium, the system comprising:
receiving means for receiving a new command;
selecting means for locating a first insertion point for the new command in a first list of commands in a command queue and for checking at least one of these conditions:
that an end of the command queue is within a first number of commands from the first insertion point; and
that inserting the new command at the first insertion point would not cause the first list to exceed a maximum list size;
reordering means for inserting the new command into the command queue at the first insertion point if the at least one of the conditions is met;
wherein if the at least one of the conditions is not met, the selecting means are configured to locate a second insertion point.

49. A data processing system comprising:
a storage array comprising at least one storage device; and
a host computer system coupled to the storage array and configured to maintain a command queue of commands to one of the at least one storage devices and to insert a new command into the command queue by selecting a first insertion point within a first list in the command queue and checking at least one of the following conditions:
that an end of the command queue is within a certain number of queue elements from the first insertion point, and
that inserting the new command at the first insertion point would not cause the first list to exceed a maximum list size;
wherein if at least one of the above conditions is not met, the host computer system is configured to select a second insertion point for the new command.
